(19) United States
(12) Patent Application Publication
(10) Pub. No.: US 2004/0096547 A1
(43) Pub. Date: May 20, 2004

(54) Healthy alternative ready-to-drink energy beverage

(76) Inventor: Mario Ferruzzi, Fairborn, OH (US)

Correspondence Address: WINSTON & STRAWN, PATENT DEPARTMENT, 1400 L STREET, N.W., WASHINGTON, DC, 20005-3502, US

(21) Appl. No.: 10/359,165

(22) Filed: Feb. 6, 2003

Related U.S. Application Data
(60) Provisional application No. 60/426,392, filed on Nov. 15, 2002.

(51) Int. Cl. A23L 1/30

(52) U.S. Cl. 426/72

(57) ABSTRACT

The present invention relates to a natural energy drink which provide an onset and steady maintenance of energy, mental alertness and nutrition to the consumer, as well as kits comprising the compositions and methods of using the compositions. In particular, the natural energy drink in the present invention includes one or more disaccharides, one or more carbohydrate complexes, one or more proteins, one or more stimulants and a vitamin premix which includes at least three vitamins. The natural energy drink may optionally, but preferably, include one or more, flavanols, acidulants, coloring agents, minerals, soluble fibers, non-caloric sweeteners, flavoring agents, preservatives, emulsifiers, oils, carbonation components, and the like, to enhance, for example, its performance in providing energy, mental alertness, organoleptic properties, and nutritional profile.

### BACKGROUND ART

The present invention relates to a nutritional ready-to-drink energy beverage that contains milk, milk-derivatives, or milk-based liquids.

Physical activity, such as exercise, particularly in the heat, places a demand on the body's carbohydrate stores, such as muscle glycogen, liver glycogen, and plasma glucose. Loss of water, redistribution and loss of electrolytes, and the depletion of endogenous carbohydrate stores are primary causes of fatigue that impairs one's work capacity. To maintain the body's physical capabilities, it is essential that water, electrolytes, carbohydrate, and other nutrients be provided in a timely and appropriate manner. Fluid replacement during physical activity has been shown to be effective in preventing dehydration and hyperthermia.

Also, it is common for consumers to experience a period of low energy and decreased mental alertness in the late afternoon, i.e., from about two or three hours after lunch to about dinnertime. It is well established that this experience is caused by a drop in blood glucose levels. Many consumers combat this dip in energy by ingesting a beverage or a candy bar to provide a source of sugar, such as sucrose, for energy.

Unfortunately for the consumer, these common sources of energy act too quickly and are not maintained over time. Instead, such sources tend to increase the blood glucose level quickly and excessively, followed by rapid depletion of blood glucose levels. Typically, the excessive blood glucose level triggers the body to produce insulin, which causes the glucose to be metabolized rapidly. Once the glucose is metabolized, the blood glucose level is lower than it was before the sugar-containing beverage or candy bar was consumed. This sequence of changes in the blood glucose level is experienced by the consumer as an initial “sugar high,” (i.e., excess levels of glucose or sugar) followed by a “sugar crash” (i.e., depletion of glucose or sugar).

Nutrition is one of the cornerstones of health, well-being, and the prevention of numerous chronic diseases. Nutritional products play an important role in these areas and attempts to provide readily available and convenient nutritional products to the general public has been a major focus in recent years. To remain healthy one must receive essential nutrients that are indispensable to human nutrition. Essential nutrients include both macronutrients, such as fats, carbohydrates and proteins, and micronutrients, such as vitamins and minerals (including trace elements and electrolytes).

Nutritionally complete and balanced foods are important for ensuring that the public receives all essential nutrients. The public should not be encouraged to receive incomplete or imbalanced nutrition with food or liquids that are perceived or marketed to have nutritional benefits. Consumption of nutritionally incomplete foods or liquids that do not contain all the essential nutrients will not necessarily provide complete nutritional well-being. Furthermore, a nutritionally imbalanced product can result in over consumption or under consumption of essential nutrients because some nutrients are presented in very high concentrations while other nutrients are presented in very low concentrations. A balance of essential nutrients, especially micronutrients, is often recommended for optimal nutritional well-being.

As an example of complete and balanced nutrition, consider the need and interaction of just three micronutrients, such as, vitamin D, calcium and phosphorus. Vitamin D is necessary for efficient in vivo utilization of calcium and phosphorus, elements that are important in normal growth and mineralization of skeleton and teeth. A deficiency in vitamin D can lead to rickets in young children and to osteomalacia in adults. Excessive consumption of vitamin D, however, can cause hypercalcemia with anorexia, nausea, polyuria, polydipsia, anxiety, pruritus and altered renal function. Furthermore, a balance of calcium and phosphorus is needed for healthy bones and teeth. A diet deficient in one of these micronutrients can directly effect the body's ability to utilize the other two micronutrients. An imbalance of micronutrients, such as excessive calcium and deficient phosphorus, and also cause health problems because a balance of these minerals is required for healthy bones and teeth. Thus, the balancing of essential nutrients in desirably quantities is necessary for health and well-being.

Milk products constitute a significant portion of the overall diet or caloric consumption of human beings. As such, milk products have a major role in maintaining the health of the public. Nutritionally optimal milk products will have a positive effect on the nutrition and the health of the public. Concentration of macronutrients in any given milk product will often depend on the nature of the product and the desirable profile developed by the manufacturer. For example, levels of macronutrients can be manipulated in products such as fat free milk, protein fortified chocolate milk and artificially sweetened ice cream.

Nutritional contents of commercially available flavored milks, including organic milk and soy milk, can vary widely. Total fat contents also vary with the product profile. For example, a fat free milk will have less total fat than a 1% milk fat product, and both of these products will have lower total fat levels than a full milk fat product. Most of the milk products, however, are deficient in a significant number of micronutrients. Many of these micronutrient-deficient milk products contain only sodium, vitamin A, vitamin C, calcium, phosphorus and possibly iron as micronutrients. These micronutrient-deficient milk products are not considered complete nutritional products and may not offer the full health benefits associated with complete nutritional products.

Some commercially available milk products can be fortified with many of the essential micronutrients. These fortified products generally have 35 to 50 percent of the daily value of many micronutrients present in a single serving. Nevertheless, even these fortified products are not complete nutritional products because some essential micronutrients are lacking from the product or are only present in insignificant or trace amounts. For example, essential micronutrients of vitamin K, folate, selenium, manganese, chromium, molybdenum and chloride are missing from these fortified milk products, resulting in an incomplete nutritional product. Furthermore, consumption of just several servings per day of these over-fortified products can lead to levels of micronutrients exceeding the recommended daily value for those fortified micronutrients. Such over consumption of a nutritionally incomplete, but somewhat nutritionally fortified product, may not result in desirable nutrition levels in the consuming public.

As with commercially available flavored milks, commercially available ice creams and frozen yogurts and commercially available refrigerated yogurts typically have incomplete and imbalanced micronutrient profiles. These ice creams and yogurts do not offer the nutritional benefits of a nutritionally complete and balanced product.

Thus, there is a need for nutritionally complete and nutritionally balanced milk products for consumption by the public without concern of over consumption of essential micronutrients especially those that are not naturally present in milk. Also, there is a need for additional components in the product to provide energy or mental alertness. The present invention now provides an energy drink that meets these needs.

### SUMMARY OF THE INVENTION

The present invention relates to a natural energy drink composition and methods that are useful for providing and maintaining energy levels and mental alertness in the consumer of the drink. The drink compositions set forth herein include beverage compositions, beverage concentrates, and essentially dry compositions so that they can be widely used in a variety of settings.

The present compositions overcome the problems associated with the prior art by rapidly increasing the blood glucose level to one that is appropriate to provide the required energy while avoiding the excessively high levels of blood glucose that could trigger an exaggerated insulin response. The compositions of the present invention maintain a desirable blood glucose level for an extended period of time after consumption to provide both energy and mental alertness.

The present invention thus relates to natural energy drinks which have been either pasteurized, ultra-pasteurized or sterilized and which are designed to include per serving size a specified percentage range of essential micronutrients. The compositions of the present invention are designed to deliver essential nutrients and phytonutrients providing both energy and mental alertness for an extended period of time post consumption. The compositions of the present invention can optionally include non-essential but nutritionally functional components. The natural energy drink of the present invention can be provided as unflavored milks, flavored milks, ice creams and yogurts.

In particularly preferred embodiments of the present invention, one or more stimulants and/or one or more plant phytochemicals are included in the present compositions.

The present invention also relates to a method of providing or maintaining energy and mental alertness in a mammal such as a human by administering to the mammal an effective amount of one of the compositions disclosed herein. When the composition is a concentrate or dry mixture, it can be reconstituted by mixing with, e.g., water prior to being administered.

### DETAILED DESCRIPTION OF PREFERRED EMBODIMENT

The present invention is directed to compositions which are useful, for example, as food and/or beverage compositions, and which provide physical energy and mental alertness as well as essential nutrients.

The term “beverage composition” as used herein denotes a composition that is single-strength and ready to drink, that is, drinkable. As used herein, “beverage concentrate” refers to a concentrate that is either in concentrated liquid form or in essentially dry mixture form, and which need to be reconstituted by addition of a liquid such as water.

The compositions utilized herein may be a beverage composition, typically comprising at least about 60% water; a beverage concentrate, typically comprising from 20% to 60% water; and an essentially dry composition, typically comprising less than about 20% water. Unless otherwise noted, all percentages herein are by weight of the composition.

The compositions of the present invention provide an onset and maintenance of energy and mental alertness as well as nutrition to the consumer. Optionally and preferably, the compositions further provide satiation and/or refreshment. The present compositions, which comprise a mixture of one or more carbohydrates, one milk protein, one natural caffeine source, a vitamin premix, and, optionally, a flavorant, a coloring agent and an antioxidant, surprisingly provide such onset and maintenance of energy and mental alertness. The following describes the compositions of the present invention in more detail.

The carbohydrates in the present invention can be a mixture of one or more monosaccharides or disaccharides, and preferably in combination with one or more complex carbohydrates. In selecting effective carbohydrates and carbohydrate levels for use in the present compositions, it is important that the carbohydrates and levels thereof which are chosen allow a sufficient rate of digestion and intestinal absorption to provide a steady maintenance of glucose, which in turn provides energy and alertness to the consumer.

It has been discovered that the monosaccharides and disaccharides provide immediate energy to the consumer while the complex carbohydrate components, are hydrolyzed in the digestive tract to provide a later, or delayed and maintained, onset of energy for the consumer. As is also set forth herein, the inclusion of one or more stimulants and/or plant phytochemical constituents enhances this internal response. Accordingly, as will be discussed more particularly herein, it is particularly preferred that one or more stimulants and/or plant phytochemical constituents are provided to the composition for optimization of the maintenance of energy and mental alertness.

The monosaccharide utilized herein is a molecule of the general formula CₙH₂ₙOₙ, wherein n is an integer equal to or greater than 3. The monosaccharide herein is digestable, i.e., capable of metabolism by a mammalian body. Non-limiting examples of monosaccharides which may be utilized herein include sorbitol, mannitol, erythrose, threose, ribose, arabinose, xylose, xylitol, ribulose, glucose, galactose, mannose, fructose, and sorbose. Preferred monosaccharides for use herein include glucose and fructose, most preferably glucose.

Preferably, one or more disaccharides are used as the source of immediate energy. The disaccharide utilized herein is a molecule of the general formula Cₙ H₂ₙ₋₂ Oₙ₋₁, wherein the disaccharide has 2 monosaccharide units connected via a glycosidic bond. In such formula, n is an integer equal to or greater than 3. The disaccharide herein is “digestable,” i.e., capable of metabolism by the human body. Non-limiting examples of disaccharides which may be utilized herein include sucrose, maltose, lactitol, maltitol, maltulose, and lactose. The most preferred disaccharide for use herein is sucrose. Preferably, sucrose is present in the amount of the range of from above 16 to 20%. More preferably, sucrose is present in the amount of the range of about 17 to 19%.

The complex carbohydrate utilized herein is an oligosaccharide, polysaccharide, and/or carbohydrate derivative, preferably an oligosaccharide and/or polysaccharide. As used herein, the term “oligosaccharide” means a digestible linear molecule having from 3 to 9 monosaccharide units, wherein the units are covalently connected via glycosidic bonds. As used herein, the term “polysaccharide” means a digestible (i.e., capable of metabolism by the human body) macromolecule having greater than 9 monosaccharide units, wherein the units are covalently connected via glycosidic bonds. The polysaccharides may be linear chains or branched. Preferably, the polysaccharide has from 9 to about 20 monosaccharide units. Carbohydrate derivatives, such as a polyhydric alcohol (e.g., glycerol), may also be utilized as a complex carbohydrate herein. As used herein, the term “digestible” means capable of metabolism by enzymes produced by the human body.

Examples of preferred complex carbohydrates include raffinoses, stachyoses, maltotrioses, maltotetraoses, glycogens, amyloses, amylopectins, polydextroses, and maltodextrins. The most preferred complex carbohydrates are maltodextrins.

Maltodextrins are a form of complex carbohydrate molecule which is several glucose units in length. The maltodextrins are hydrolyzed into glucose in the digestive tract where they provide an extended source of glucose. Maltodextrins may be spray-dried carbohydrate ingredients made by controlled hydrolysis of corn starch. Preferably, maltodextrin is present in the amount of the range of from about 5 to about 15%, more preferably in the range of from about 8 to about 12%.

The protein source may be selected from a variety of materials, including without limitation, milk protein, whey protein, caseinate, soy protein, egg whites, gelatins, collagen and combinations thereof. Included in the protein source are lactose-free skim milk, milk protein isolate, and whey protein isolate. It is also contemplated to use soy milk with the present compositions. As used herein, soy milk refers to a liquid made by grinding dehulled soy beans, mixing with water, cooking and recovering the dissolved soy milk out of the beans. Preferably, whey protein is used as the protein source in the present invention. Preferably, the amount of protein is between about 0.1% and 1.5%, and more preferably, between 0.2% and 1%. In addition to providing protein, these amounts provide a milk-like consistency to the beverage. Also, the final color or translucency of the beverage can be varied by the amount of protein that is included.

The compositions of the present invention further comprise a stimulant to provide mental alertness. The inclusion of one or more stimulants serves to provide further maintenance of energy to the user by delaying the glycemic response associated with ingestion of the composition, by causing metabolic alteration of glucose utilization, by directly stimulating the brain by translocation across the blood brain barrier or by other mechanisms. Because one or more stimulants will contribute to the onset, and particularly maintenance of energy wherein the composition is ingested, it is a particularly preferred embodiment of the present invention to include one or more stimulants.

As is commonly known in the art, stimulants can be obtained by extraction from a natural source or can be synthetically produced. Non-limiting examples of stimulants include methylxanthines, e.g., caffeine, theobromine, and theophylline. Additionally, numerous other xanthine derivatives have been isolated or synthesized, which may be utilized as a stimulant in the compositions herein. See e.g., Bruns, Biochemical Pharmacology, Vol. 30, pp. 325-333 (1981). It is preferred that the natural sources of these materials be used.

Preferably, one or more of these stimulants are provided by coffee, tea, kola nut, cacao pod, Yerba Mate', yaupon, guarana paste, and yoco. Natural plant extracts are the most preferred sources of stimulants as they may contain other compounds that delay the bioavailability of the stimulant thus they may provide mental refreshment and alertness without tension or nervousness.

The most preferred methylxanthine is caffeine. Caffeine may be obtained from the aforementioned plants and their waste or, alternatively, may be synthetically prepared. Preferred botanical sources of caffeine which may be utilized as a complete or partial source of caffeine include green tea extract, guarana, Yerba Mate' extract, black tea, cola nuts, cocoa, and coffee. As used herein, green tea extract, guarana, coffee, and Yerba Mate' extract are the most preferred botanical sources of caffeine, most preferably green tea extract and Yerba Mate' extract. Besides serving as a source of caffeine, green tea extract has the additional advantage of being a flavanol as will be discussed later. Yerba Mate' extract may have the additional benefit of an appetite suppressing effect and may be included for this purpose as well.

The green tea extract can be obtained from the extraction of unfermented teas, fermented teas, partially fermented teas, and mixtures thereof. Preferably, the tea extracts are obtained from the extraction of unfermented and partially fermented teas. The most preferred tea extracts are obtained from green tea. Both hot and cold extracts can be used in the present invention. Suitable methods for obtaining tea extracts are well known. See e.g., Ekanavake, U.S. Pat. No. 5,879,733; Tsai, U.S. Pat. No. 4,935,256; Lunder, U.S. Pat. No. 4,680,193; and Creswick U.S. Pat. No. 4,668,525.

Preferably, green tea extract and Yerba Mate' extract are present in the amounts of between about 0.1 and about 0.4% and between about 0.1 and about 0.5%, respectively. More preferably, they are present in the amounts of between about 0.15 and about 0.35 percent, and between about 0.15 and 0.25%, respectively. While the greater amounts provide greater stimulation, they also provide a less desirable taste to the beverage. This can be compensated for by the addition of the higher amounts of carbohydrate or by the addition of an artificial sweetener so that the final taste of the beverage is palatable.

The compositions herein further comprise at least three, and preferably more, vitamins provided by a vitamin premix. The U.S. Recommended Daily Intake (USRDI) for vitamins and minerals are defined and set forth in the Recommended Daily Dietary Allowance-Food and Nutrition Board, National Academy of Sciences-National Research Council. Various combinations of these vitamins can be used.

Non-limiting examples of such vitamins, include choline bitartate, niacinamide, thiamin, folic acid, d-calcium pantothenate, biotin, vitamin A, vitamin C, vitamin B₁ hydrochloride, vitamin B₂, vitamin B₃, vitamin B₆ hydrochloride, vitamin B₁₂, vitamin D, vitamin E acetate, vitamin K. Preferably, at least three vitamins are selected from choline bitartate, niacinamide, thiamin, folic acid, d-calcium pantothenate, biotin, vitamin A, vitamin C, vitamin B₁ hydrochloride, vitamin B₂, vitamin B₃, vitamin B₆ hydrochloride, vitamin B₁₂, vitamin D, vitamin E acetate, vitamin K. More preferably, the composition comprises vitamin C and two or more other vitamins selected from choline bitartate, niacinamide, thiamin, folic acid, d-calcium pantothenate, biotin, vitamin A, vitamin B₁ hydrochloride, vitamin B₂, vitamin B₃, vitamin B₆ hydrochloride, vitamin B₁₂, vitamin D, vitamin E acetate, vitamin K. In an especially preferred embodiment of the present invention, a composition comprises vitamin choline bitartate, niacinamide, folic acid, d-calcium panothenate, vitamin A, vitamin B₁ hydrochloride, vitamin B₂, vitamin B₆ hydrochloride, vitamin B₁₂, vitamin C, vitamin E acetate. Wherein the product comprises one of these vitamins, the product preferably comprises at least 5%, preferably at least 25%, and most preferably at least 35% of the USRDI for such vitamin.

Commercially available vitamin A sources may also be included in the present compositions. As used herein, “vitamin A” includes, but is not limited to, vitamin A (retinol), beta-carotene, retinol palmitate, and retinol acetate. Vitamin A sources include other provitamin A carotenoids such as those found in natural extracts that are high in carotenoids with provitamin A activity. Beta-carotene can also serve as a coloring agent as will be discussed later. Commercially available sources of vitamin B₂ (also known as riboflavin) may be utilized in the present compositions. Commercially available sources of vitamin C can be used herein. Encapsulated ascorbic acid and edible salts of ascorbic acid can also be used.

Nutritionally supplemental amounts of other vitamins which may be incorporated herein include, but are not limited to, choline bitartate, niacinamide, thiamin, folic acid, dcalcium pantothenate, biotin, vitamin B₁ hydrochloride, vitamin B₃, vitamin B₆ hydrochloride, vitamin B₁₂, vitamin D, vitamin E acetate, vitamin K.

The compositions of the present invention may further comprise additional optional components to enhance, for example, their perfonnance in providing energy, mental alertness, organoleptic properties, and nutritional profile. For example, one or more, flavanols, acidulants, coloring agents, minerals, soluble fibers, non-caloric sweeteners, flavoring agents, preservatives, emulsifiers, oils, carbonation components, and the like may be included in the compositions herein. Such optional components may be dispersed, solubilized, or otherwise mixed into the present compositions. These components may be added to the compositions herein provided they do not substantially hinder the properties of the beverage composition, particularly the provision of energy and mental alertness. Non-limiting examples of optional components suitable for use herein are given below.

An optional, but particularly preferable component of the present invention is one or more plant phytochemical constituents. This would include flavanols or other phytochemicals which are in essence “healthy.” The inclusion of one or more flavanols serves to delay the glycemic response associated with ingestion of the present compositions, thus providing further maintenance of energy to the user. Because one or more flavanols will contribute to the onset, and particularly maintenance of energy wherein the composition is ingested, it is particularly preferred that one or more flavanols be included.

Flavanols are natural substances present in a variety of plants (e.g., fruits, vegetables, and flowers). The flavanols which may be utilized in the present invention can be extracted from, for example, fruit, vegetables, or other natural sources by any suitable method well known to those skilled in the art. For example, flavanols may be extracted from either a single plant or mixtures of plants. Many fruits, vegetables, flowers and other plants containing flavanols are known to those skilled in the art. Alternatively, these flavanols may be prepared by synthetic or other appropriate chemical methods and incorporated into the present compositions. Flavanols, including catechin, epicatechin, and their derivatives are commercially available.

The flavanols are preferably utilized in an amount of from about 0.001% to about 5%, more preferably from about 0.001% to about 2%, even more preferably from about 0.01% to about 1%, and most preferably from about 0.01% to about 0.05% by weight of the composition. When a flavanol is utilized in the present beverage concentrates, the amount of flavanol present in the beverage concentrate or essentially dry composition is preferably at least from about 0.001% to about 10%, more preferably from about 0.01% to about 7%, even more preferably from about 0.05% to about 2%, and most preferably from about 0.07% to about 0.4% of flavanol, by weight of the concentrate or essentially dry composition.

The present compositions may optionally but preferably further comprise one or more acidulants. An amount of an acidulant may be used to maintain the pH of the composition. Compositions of the present invention preferably have a pH of from about 2 to about 8, more preferably from about 2 to about 5, even more preferably from about 2 to about 4.5, and most preferably from about 2.7 to about 4.2. Beverage acidity can be adjusted to and maintained within the requisite range by known and conventional methods, e.g., the use of one or more acidulants. Typically, acidity within the above recited ranges is a balance between maximum acidity for microbial inhibition and optimum acidity for the desired beverage flavor.

Organic as well as inorganic edible acids may be used to adjust the pH of the beverage. The acids can be present in their undissociated form or, alternatively, as their respective salts, for example, potassium or sodium hydrogen phosphate, potassium or sodium dihydrogen phosphate salts. The preferred acids are edible organic acids which include citric acid, phosphoric acid, malic acid, fumaric acid, adipic acid, gluconic acid, tartaric acid, ascorbic acid, acetic acid, phosphoric acid or mixtures thereof. The most preferred acids are citric and phosphoric acids. Preferably, citric acid and phosphoric acid are present in the amount of from about 0.1% to about 0.5% and from about 0.01% to about 0.05%, respectively. More preferably, citric acid and phosphoric acid are present in the amount of from about 0.15% to about 0.35% and from about 0.01% to about 0.03%, respectively.

The acidulant can also serve as an antioxidant to stabilize beverage components. Examples of commonly used antioxidant include but are not limited to ascorbic acid, EDTA (ethylenediaminetetraacetic acid), and salts thereof.

Small amounts of one or more coloring agents may be utilized in the compositions of the present invention. Beta-carotene is preferably used. Riboflavin and FD&C dyes (e.g., yellow #5, blue #2,red #40) and/or FD&C lakes may also be used. By adding the lakes to the other powdered ingredients, all the particles, in particular the colored iron compound, are completely and uniformly colored and a uniformly colored beverage mix is attained. Additionally, a mixture of FD&C dyes or a FD&C lake dye in combination with other conventional food and food colorants may be used. Additionally, other natural coloring agents may be utilized including, for example, chlorophylls and chlorophyllins, as well as fruit, vegetable, and/or plant extracts such as grape, black currant, aronia, carrot, beetroot, red cabbage, and hibiscus. Natural colorants are preferred for “all natural” drink products.

The amount of coloring agent used will vary, depending on the agents used and the color intensity desired in the finished product. The amount can be readily determined by one skilled in the art. Generally, if utilized, the coloring agent should be present at a level of from about 0.0001% to about 0.5%, preferably from about 0.001% to about 0.1%, and most preferably from about 0.004% to about 0.1%, by weight of the composition.

The compositions herein are optionally, but preferably, fortified with one or more minerals. The U.S. Recommended Daily Intake (USRDI) for minerals are defined and set forth in the Recommended Daily Dietary Allowance-Food and Nutrition Board, National Academy of Sciences-National Research Council.

Unless otherwise specified herein, wherein a given mineral is present in the composition, the composition typically comprises at least about 1%, preferably at least about 5%, more preferably from about 10% to about 200%, even more preferably from about 40% to about 150%, and most preferably from about 60% to about 125% of the USRDI of such mineral. Unless otherwise specified herein, wherein a given mineral is present in the composition, the composition comprises at least about 1%, preferably at least about 5%, more preferably from about 10% to about 200%, even more preferably from about 20% to about 150%, and most preferably from about 25% to about 120% of the USRDI of such vitamin.

Minerals which may optionally be included in the compositions herein are, for example, calcium, potassium, magnesium, zinc, iodine, iron, and copper. Any soluble salt of these minerals suitable for inclusion edible compositions can be used, for example, magnesium citrate, magnesium gluconate, magnesium sulfate, zinc chloride, zinc sulfate, potassium iodide, copper sulfate, copper gluconate, and copper citrate.

Calcium is a particularly preferred mineral for use in the present invention. Preferred sources of calcium include, for example, calcium-citrate-lactate, amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium titrate, calcium gluconate, calcium realate, calcium tantrate, and calcium lactate, and in particular calcium citrate-malate. The form of calcium citratemalate is described in, e.g., Mehansho et al., U.S. Pat. No. 5,670,344; or Diehl et al., U.S. Pat. No. 5,612,026. Preferred compositions of the present invention will comprise from about 0.01% to about 0.5%, more preferably from about 0.03% to about 0.2%, even more preferably from about 0.05% to about 0.15%, and most preferably from about 0.1% to about 0.15% of calcium, by weight of the product.

Iron may also be utilized in the compositions and methods of the present invention. Acceptable forms of iron are well-known in the art. The amount of iron compound incorporated into the product will vary widely depending upon the level of supplementation desired in the final product and the targeted consumer. Iron fortified compositions of the present invention typically contain from about 5% to about 100%, preferably from about 15% to about 50%, and most preferably about 20% to about 40% of the USRDI for iron.

One or more soluble fibers may also optionally be included in the compositions of the present invention to provide, for example, satiation and refreshment, and/or nutritive benefits. Soluble dietary fibers are a form of carbohydrates which cannot be metabolized by the enzyme system produced by the human body and which pass through the small intestine without being hydrolyzed (and, thus, are not included within the definition of complex carbohydrate herein). Without intending to be limited by theory, since soluble dietary fibers swell in the stomach, they slow down gastric emptying thus prolonging the retention of nutrients in the intestine which results in a feeling of satiation.

Soluble fibers which can be used singularly or in combination in the present invention include but are not limited to pectins, psyllium, guar gum, xanthan gum, alginates, gum arabic, inulin, agar, and carrageenan. Preferred among these soluble fibers are at least one of guar gum, xanthan, and carrageenan, most preferably guar gum or xanthan gum. These soluble fibers may also serve as stabilizing agents in this invention.

Particularly preferred soluble fibers for use herein are glucose polymers, preferably those which have branched chains. Preferred among these soluble fibers is one marketed under the trade name Fi.beta.ersol2, commercially available from Matsutani Chemical Industry Co., Itami City, Hyogo, Japan.

Pectins are preferred soluble fibers herein. Even more preferably, low methoxy pectins are used. The preferred pectins have a degree of esterification higher than about 65%, and are obtained by hot acidic extraction from citrus peels and may be obtained, for example, from Danisco Co., Braband, Denmark.

The natural energy drink in the present invention is sweet enough to wash the strong flavors of the other components due to the presence of the aforementioned carbohydrate sources. In addition, effective levels of non-caloric sweeteners may also optionally be used, in the present invention to enhance the organoleptic and sweetness quality of the compositions, but not as a replacement of the carbohydrate source. Non-limiting examples of non-caloric sweeteners include aspartame, saccharine, cyclamates, acesulfame K, L-aspartyl-L-phenylalanine lower alkyl ester sweeteners, L-aspartyl-D-alanine amides, L-aspartyl-D-serine amides, L-aspartyl-hydroxymethyl alkane amide sweeteners, L-aspartyl-1-hydroxyethylalkane amide sweeteners, glycyrrhizins, and synthetic alkoxy aromatics. Aspartame and acesulfame-K are the most preferred non-caloric sweeteners utilized herein, and may be utilized alone or in combination.

Wherein one or more non-caloric sweeteners are utilized herein, the total non-caloric sweetener is preferably utilized at levels from about 0.0001% to about 5%, more preferably from about 0.001% to about 3%, still more preferably from about 0.005% to about 2%, even more preferably from about 0.01% to about 1%, and most preferably from about 0.01% to about 0.05%, by weight of the composition.

One or more flavoring agents are recommended for the present invention in order to enhance their palatability. Any natural or synthetic flavor agent can be used in the present invention. For example, one or more botanical and/or fruit flavors may be utilized herein. As used herein, such flavors may be synthetic or natural flavors.

Particularly preferred fruit flavors are exotic and lactonic flavors such as, for example, passion fruit flavors, mango flavors, pineapple flavors, cupuacu flavors, guava flavors, cocoa flavors, papaya flavors, peach flavors, and apricot flavors. Besides these flavors, a variety of other fruit flavors can be utilized such as, for example, apple flavors, citrus flavors, grape flavors, raspberry flavors, cranberry flavors, cherry flavors, and the like. These fruit flavors can be derived from natural sources such as fruit juices and flavor oils, or may alternatively be synthetically prepared. The natural flavorants are preferred for “all natural” drinks.

Preferred botanical flavors include, for example, aloe vera, guarana, ginseng, ginkgo, hawthorn, hibiscus, rose hips, chamomile, peppermint, fennel, ginger, licorice, lotus seed, schizandra, saw palmetto, sarsaparilla, safflower, St. John's Wort, curcuma, cardimom, nutmeg, cassia bark, buchu, cinnamon, jasmine, haw, chrysanthemum, water chestnut, sugar cane, lychee, bamboo shoots, vanilla, coffee, and the like. Preferred among these is guarana, ginseng, ginko. Besides serving as sources of stimulants, tea extracts and coffee can also be used as a flavoring agent. In particular, the combination of tea flavors, preferably green tea or black tea flavors (preferably green tea), optionally together with fruit flavors has an appealing taste.

The flavor agent can also comprise a blend of various flavors. If desired, the flavor in the flavoring agent may be formed into emulsion droplets which are then dispersed in the beverage composition or concentrate. Because these droplets usually have a specific gravity less than that of water and would therefore form a separate phase, weighting agents (which can also act as clouding agents) can be used to keep the emulsion droplets dispersed in the beverage composition or concentrate. Examples of such weighting agents are brominated vegetable oils (BVO) and resin esters, in particular the ester gums. See L. F. Green, Developments in Soft Drinks Technology, Vol. 1, Applied Science Publishers Ltd., pp. 87-93 (1978) for a further description of the use of weighting and clouding agents in liquid beverages. Typically the flavoring agents are conventionally available as concentrates or extracts or in the form of synthetically produced flavoring esters, alcohols, aldehydes, terpenes, sesquiterpenes, and the like.

Optionally, one or more preservatives may additionally be utilized herein. Preferred preservatives include, for example, sorbate, benzoate, and polyphosphate preservatives. Preferably, wherein a preservative is utilized herein, one or more sorbate or benzoate preservatives (or mixtures thereof) are utilized. Sorbate and benzoate preservatives suitable for use in the present invention include sorbic acid, benzoic acid, and salts thereof, including (but not limited to) calcium sorbate, sodium sorbate, potassium sorbate, calcium benzoate, sodium benzoate, potassium benzoate, and mixtures thereof. Sorbate preservatives are particularly preferred. Potassium sorbate is particularly preferred for use in this invention.

Wherein a composition comprises a preservative, the preservative is preferably included at levels from about 0.0005% to about 0.5%, more preferably from about 0.001% to about 0.4% of the preservative, still more preferably from about 0.001% to about 0.1%, even more preferably from about 0.001% to about 0.05%, and most preferably from about 0.003% to about 0.03% of the preservative, by weight of the composition. Wherein the composition comprises a mixture of one or more preservatives, the total concentration of such preservatives is preferably maintained within these ranges.

The amount of water utilized in the present beverage compositions is such that it is suitable as a dilute, ready-to-drink beverage. Typically, the present beverage compositions comprise at least 60% to about 85% water, preferably at least about 70% water, still more preferably at least about 75% water, even more preferably at least about 80% water, and most preferably at least about 83% water.

The present beverage may also be in the form of a concentrate. These beverage concentrates according to the present invention may be provided as, for example, a syrup and/or an aqueous concentrate. The beverage concentrate is typically formulated to provide a drinkable beverage composition wherein the concentrate is reconstituted or diluted with water or other aqueous fluid or liquid.

The amount of water utilized in the present beverage concentrates is such that it is suitable as a concentrate, typically in the form of a syrup or aqueous concentrate, which is ready-to-drink upon further dilution with water or other aqueous liquid. Typically, the present beverage concentrates comprise from 20% to 60% water, preferably from about 20% to about 50% water, and most preferably from about 20% to about 40% water.

The present beverage also may be a concentrate in the form of an essentially dry composition. These compositions are typically in, for example, powder, granule, or tablet form. The essentially dry beverage compositions are may be diluted with water or other aqueous fluids, or may be incorporated into other solids such as, for example, bars (e.g., cereal bars, breakfast bars, energy bars, and nutritional bars). The amount of water utilized in the present essentially dry compositions is typically less than about 20%, preferably less than about 10%, more preferably less than about 5%, and most preferably less than about 3%, all by weight of the composition. In these dry compositions, the carbohydrate is present in an amount of between about 30% and about 75% by weight of the composition; the protein is present in an amount of above about 1 and about 10% by weight of the composition; and the stimulant is present in an amount of about 1 and about 10% by weight of the composition.

The beverage concentrates are particularly useful as they may be transported and stored more conveniently than the final beverage product due to the lesser content of water therein. After reconstitution, these beverages provide maintained energy to the consumer without rapid and transient peaks of glucose levels in the blood.

The present compositions are made according to methods which will be well known by the ordinarily skilled artisan. For convenience, non-limiting examples of methods of making follow.

To illustrate, the compositions of the present invention may be prepared by dissolving, dispersing, or otherwise mixing all components singularly or in suitable combinations together and in water where appropriate, agitating with a mechanical stirrer until all of the ingredients have been solubilized or adequately dispersed. Where appropriate, all separate solutions and dispersed may then be combined. When using tea extracts which typically are pH sensitive, it is important to adjust the desired pH with an acidulant and/or buffer system before adding the tea extracts to the mixture. Wherein a shelf stable composition is desired, the final mixture can optionally, but preferably, be either pasteurized, ultra-pasteurized, sterilized or filled aseptically at appropriate process conditions.

In making a beverage composition, a beverage concentrate may optionally be formed first. One method to prepare the concentrate form of the beverage composition would be to start with less than the required volume of water that is used in the preparation of the beverage composition. Another method would be to partially dehydrate the finally prepared beverage compositions to remove only a portion of the water and any other volatile liquids present. Dehydration may be accomplished in accordance with well known procedures, such as evaporation under vacuum. The concentrate can be in the form of a relatively thick liquid. A syrup is typically formed by adding suitable ingredients such as electrolytes or emulsions to the beverage concentrate. The syrup is then mixed with water or another aqueous fluid to form a finished beverage or finished beverage concentrate. The weight ratio of water to syrup is typically from about 1:1 to about 5:1.

The final beverage is bottled or packaged in 150 ml containers, either in bottles or in Tetrabriks. Preferably, amber PET or glass bottles are appropriately sterilized before being filled by the pasteurized, ultrapasteurized or sterilized beverage.

In addition to beverages, and liquid or powdered concentrates, the present invention can also be prepared in the form of an ice cream, yogurt or pudding composition depending upon consistency and storage temperature as is generally known to the skilled artisan.

In the method of the invention, energy and mental alertness are provided to or maintained in a mammal by administering to the mammal an effective amount of one of these beverage compositions. The amount of beverage can vary from small amounts such as about 50 ml to as much as about 500 ml or more. Generally, an amount of 100 to 300 ml and preferably 120 to 250 ml provide an effective amount when so administered.

### EXAMPLES

The following are non-limiting examples of the present compositions which are prepared utilizing conventional methods. The following examples are provided to illustrate the invention and are not intended to limit the scope thereof in any manner.

### Example 1

A beverage composition is prepared by combining the following components in a conventional manner:

| Component | Wt. % |
|---|---|
| Sucrose | 18 |
| Whey Protein Isolate | 1 |
| Yerba Mate' Extract | 0.35 |
| Green Tea Extract | 0.25 |
| Citric Acid | 0.25 |
| Phosphoric Acid (70%) | 0.02 |
| Beta-carotene | 0.01 |
| Ascorbic Acid | 0.01 |
| Vitamin Fortification Premix | 0.26 |
| Water | 79.85 |
| Total | 100 |

The vitamin fortification premix consists of: choline bitartate, niacinamide, folic acid, dcalcium panothenate, vitamin A, vitamin B₁ hydrochloride, vitamin B₂, vitamin B₆ hydrochloride, vitamin B₁₂, vitamin C, vitamin E acetate, and is intended to provide a minimum 20% RDI of said vitamins.

### Example 2

A beverage composition is prepared by combining the following components in a conventional manner:

| Component | Wt. % |
|---|---|
| Sucrose | 16 |
| Maltodextrin | 10 |
| Whey Protein Isolate | 1 |
| Yerba Mate' Extract | 0.35 |
| Green Tea Extract | 0.25 |
| Citric Acid | 0.25 |
| Phosphoric Acid (70%) | 0.02 |
| Beta-carotene | 0.01 |
| Ascorbic Acid | 0.01 |
| Vitamin Fortification Premix | 0.26 |
| Water | 71.85 |
| Total | 100 |

The vitamin fortification premix consists of: choline bitartate, niacinamide, folic acid, dcalcium panothenate, vitamin A, vitamin B₁ hydrochloride, vitamin B₂, vitamin B₆ hydrochloride, vitamin B₁₂, vitamin C, vitamin E acetate, and is intended to provide a minimum 20% RDI of said vitamins.

### Example 3

A beverage composition is prepared by combining the following components in a conventional manner:

| Component | Wt. % |
|---|---|
| Sucrose | 18 |
| Whey Protein Isolate | 0.5 |
| Yerba Mate' Powder | 0.35 |
| Green Tea solids | 0.20 |
| Citric Acid | 0.25 |
| Phosphoric Acid (70%) | 0.03 |
| Beta-carotene | 0.01 |
| Ascorbic Acid | 0.01 |
| Vitamin Fortification Premix | 0.26 |
| Low Methoxy Pectin | 0.05 |
| Water | 80.34 |
| Total | 100 |

The vitamin fortification premix consists of: choline bitartate, niacinamide, folic acid, dcalcium panothenate, vitamin A, vitamin B₁ hydrochloride, vitamin B₂, vitamin B₆ hydrochloride, vitamin B₁₂, vitamin C, vitamin E acetate, and is intended to provide a minimum 20% RDI of said vitamins.

### Example 4

A beverage composition is prepared by combining the following components in a conventional manner:

| Component | Wt. % |
|---|---|
| Sucrose | 18 |
| Whey Protein Isolate | 0.25 |
| Yerba Mate' Powder | 0.25 |
| Green Tea solids | 0.20 |
| Citric Acid | 0.25 |
| Phosphoric Acid (70%) | 0.03 |
| Beta-carotene | 0.01 |
| Ascorbic Acid | 0.01 |
| Vitamin Fortification Premix | 0.26 |
| Low Methoxy Pectin | 0.025 |
| Water | 80.665 |
| Total | 100 |

The vitamin fortification premix consists of: choline bitartate, niacinamide, folic acid, dcalcium panothenate, vitamin A, vitamin B₁ hydrochloride, vitamin B₂, vitamin B₆ hydrochloride, vitamin B₁₂, vitamin C, vitamin E acetate, and is intended to provide a minimum 20% RDI of said vitamins.

### Example 5

The formulations of Examples 1-4 were prepared and taste tested by a panel with the following results:

The beverage of Example 1 may be characterized as juice like in both flavor and acidity. Aroma and flavor are reminiscent of a strong citrus beverage with mild woody herbal notes. Sweetness is well balanced by the acidity. Mild astringency is noted, most likely from the herbal extracts, giving a “healthy” tonic quality to the beverage. Product appearance is that of a natural juice nectar with a cloudy orange appearance. Cloudiness is characteristic of commercially available yogurt-waters.

The beverage of Example 2 has an smooth rounded fruity taste. Sweetness is also well balanced by the acidity. A hint of tea astringency is noted giving a “healthy” tonic quality to the beverage. However, astringency of example 2 is less than other examples. Mouthfeel of example 2 is clearly thicker with more overall body. Product appearance is that of a natural juice nectar with a cloudy orange appearance. This product is more reminiscent of a thicker drinking-yogurt in both consistency and appearance than the other examples.

The beverage of Example 3 has a more intense overall flavor. Flavor reminiscent of a citrus blend with woody herbal floral notes. Sweetness is well balanced by the acidity. A certain unique astringency is noted providing a tea like quality to the juice like beverage. No off flavor from the fortification blend is noted. Mouthfeel of this product is smooth and consistent with minimal aftertaste. Product appearance is that of a natural juice nectar with a cloudy orange appearance. Cloudiness is close in appearance to commercially available natural yogurt-waters.

The beverage of Example 4 has an smooth rounded fruity taste similar to a citrus blend. Product is very juice like in consistence and acidity. Sweetness is well balanced by the acidity. A hint of tea astringency is noted giving a “healthy” tonic quality to the beverage. No discemable off flavor from the fortification blend was noted. Product appearance is that of a natural juice nectar with a cloudy orange appearance.

Accordingly, the present invention provides a wide variety of healthy, ready to drink energy compositions as desired. Both “all natural” formulations as well as those that contain synthetic or other ingredients that are not considered to be natural can be prepared as necessary, either as a ready to drink liquid, or as liquid or powder concentrates that can be reconstituted with water or other aqueous fluids to form the final product. A wide variety of products, including milk type beverages, both hot and cold, as well as other dairy products such as yogurts, puddings, and ice creams can be prepared. These can be provided with essentially any type of flavoring, and the dairy products can be provided with the typical additives, such as liquid or dry inclusions, including syrups, fruit, nut, confectionery or chocolate pieces, or the like, depending upon the desire of the product formulator. It is intended that the appended claims cover all such variations and modifications of the invention.

What is claimed is:

1. An energy drink composition, comprising:
a carbohydrate in an amount of above 16% to about 20% by weight of composition;
a protein in an amount of from about 0.1% to about 1.5% by weight of the composition;
a stimulant in an amount of from about 0. 1% to about 1.5% by weight of the composition; and
a vitamin premix in a vitamin fortifying amount and which includes at least three different vitamins,
wherein said natural energy drink when consumed by a person provides energy, stimulation, and nutrition.

2. The composition according to claim 1, wherein the carbohydrate is a disaccharide.

3. The composition according to claim 2, wherein the disaccharide is sucrose and is present in an amount of about 17% to about 19% by weight of the composition.

4. The composition according to claim 1, which further comprises a carbohydrate complex in an amount of from about 5% to about 15% by weight of the composition.

5. The composition according to claim 4, wherein the carbohydrate complex is maltodextrin and is present in an amount of from about 8% to about 12% by weight of the composition.

6. The composition according to claim 1, wherein the protein is milk protein, whey protein, caseinate, soy protein, egg whites, gelatins, collagen or combinations thereof.

7. The composition according to claim 6, wherein the protein is whey protein and is present in an amount of from about 0.2% to about 1%.

8. The composition according to claim 1, wherein the stimulant is caffeine.

9. The composition according to claim 8, wherein the caffeine is obtained from green tea extract, guarana, Yerba Mate' extract, black tea, cola nuts, cocoa, or coffee.

10. The composition according to claim 8, wherein the caffeine is obtained from green tea extract and Yerba Mate' extract, wherein said green tea extract and Yerba Mate' extract are present in the amounts of from about 0.1 and about 0.4% and between about 0.1 and about 0.5%, respectively.

11. The composition according to claim 8, wherein the caffeine is obtained from green tea extract and Yerba Mate' extract, wherein said green tea extract and Yerba Mate' extract are present in the amounts of between about 0.15 and about 0.35%, and between about 0.15 and 0.25%, respectively.

12. The composition according to claim 1, wherein the vitamin premix includes at least three of choline bitartate, niacinamide, thiamin, folic acid, d-calcium pantothenate, biotin, vitamin A, vitamin C, vitamin B₁ hydrochloride, vitamin B₂, vitamin B₃, vitamin B₆ hydrochloride, vitamin B₁₂, vitamin D, vitamin E acetate or vitamin K.

13. The composition according to claim 12, wherein the vitamin premix comprises vitamin C and two or more other vitamins selected from choline bitartate, niacinamide, thiamin, folic acid, d-calcium pantothenate, biotin, vitamin A, vitamin B₁ hydrochloride, vitamin B₂, vitamin B₃, vitamin B₆ hydrochloride, vitamin B₁₂, vitamin D, vitamin E acetate, vitamin K.

14. The composition according to claim 1, further comprising one or more of a flavanol; and acidulant; a coloring agent; a mineral; a soluble fiber; a sweetener; a flavoring agent; an antioxidant or a preservative.

15. The composition according to claim 14, which includes an acidulant of citric acid, phosphoric acid, malic acid, fumaric acid, adipic acid, gluconic acid, tartaric acid, ascorbic acid, acetic acid, phosphoric acid or mixtures thereof; and a coloring agent of betacarotene.

16. The composition according to claim 14, which includes an acidulant mixture of citric acid and phosphoric acid which are present in an amount of from about 0.1% to about 0.5% and from about 0.01% to about 0.05 %, respectively; and beta-carotene present in an amount of about 0.005% to about 0.02%.

17. The composition according to claim 1, further comprising water in an amount of from about 20% to about 85% by weight of the composition.

18. A natural energy drink composition, comprising:
a carbohydrate in an amount of above 16% to about 20% by weight of the composition;
a protein of milk protein, whey protein, caseinate, soy protein, egg white, gelatin, collagen or combinations thereof in an amount of from about 0.1% to about 1.5% by weight of the composition;
a stimulant of green tea extract, guarana, Yerba Mate' extract, black tea, cola nuts, cocoa, or coffee in an amount of from about 0.1% to about 1.5% by weight of the composition;
a vitamin premix in a vitamin fortifying amount and which includes at least three different vitamins of choline bitartate, niacinamide, thiamin, folic acid, d-calcium pantothenate, biotin, vitamin A, vitamin C, vitamin B₁ hydrochloride, vitamin B₂, vitamin B₃, vitamin B₆ hydrochloride, vitamin B₁₂, vitamin D, vitamin E acetate or vitamin K;
an acidulant mixture of citric acid and phosphoric acid present in the amount of from about 0.1% to about 0.5% and from about 0.01% to about 0.05%, respectively, by weight of the composition;
beta-carotene in an amount of 0.005% to 0.02%, by weight of the composition; and
water; and
optionally, one or more of a flavanol; a mineral; a soluble fiber; a sweetener; a flavoring agent; an antioxidant or a preservative,
wherein said natural energy drink when consumed by a person provides energy, stimulation, and nutrition.

19. The composition according to claim 18, wherein the water is present in an amount of above 60% to about 85% by weight of the composition.

20. The composition according to claim 18, in the form of a concentrate that contains between 20% and 60% water, wherein a beverage can be made by combining the concentrate with an aqueous fluid.

21. The composition according to claim 18, in the form of an essentially dry beverage-forming composition that contains less than 20% water, wherein the carbohydrate in present in an amount of between about 30% and about 75% by weight of the composition; the protein is present in an amount of above about 1 and about 10% by weight of the composition; and the stimulant is present in an amount of about 1 and about 10% by weight of the composition, wherein a beverage can be made by combining the composition with an aqueous fluid.

22. A method of providing or maintaining energy and mental alertness to a mammal which comprises administering to the mammal an effective amount of a composition according to claim 1.

23. A method of providing or maintaining energy and mental alertness to a mammal which comprises administering to the mammal an effective amount of a composition according to claim 19.

24. A method of providing or maintaining energy and mental alertness to a mammal which comprises preparing a beverage composition by combining the composition according to claim 20 with an aqueous fluid and administering to the mammal an effective amount of the beverage composition.

25. A method of providing or maintaining energy and mental alertness to a mammal which comprises preparing a beverage composition by combining the dry composition according to claim 21 with an aqueous fluid and administering to the mammal an effective amount of the beverage composition.
